(19) United States
(12) Patent Application Publication
(10) Pub. No.: US 2017/0325270 A1
(43) Pub. Date: Nov. 9, 2017

(54) System and Method for Device Identification and Authentication

(71) Applicant: Futurewei Technologies, Inc., Plano, TX (US)

(72) Inventors: Nathan Edward Tenny, Poway, CA (US); Hui Jin, Shenzhen (CN)

(21) Appl. No.: 15/148,771

(22) Filed: May 6, 2016

(51) Int. Cl. H04W 76/02; H04W 88/04

(52) U.S. Cl. CPC H04W 76/02; H04W 88/04

(57) ABSTRACT

A method for providing relay services to a remote device (RD) includes receiving a relay service request from the RD, the relay service request including at least an identifier of the RD, and the RD is not in active radio communications with an entity of the communications system, restricting relay services on communications from the RD, sending a first authentication request including at least a portion of the relay service request to a network node, receiving a second authentication response confirming the identity of the RD, and unrestricting the relay services on communications from the RD.

### TECHNICAL FIELD

The present disclosure relates generally to digital communications, and more particularly to a system and method for device identification and authentication.

### BACKGROUND

Remote devices (RDs) are typically objects with embedded electronics, software, sensors, as well as connectivity that enable the objects to exchange information with an operator, a manufacturer, a user, and/or other connected objects. The remote devices are typically small and are battery powered. As an example, remote devices used in sensing operations (e.g., weather, fire, security, health, automotive, and so on) are expected to operate for years without battery replacement or user intervention. At the same time, these remote devices may be required to be physically small (for portability, to be deployed in a limited space, etc.), which may limit the feasible size of their batteries. Therefore, battery life is an important consideration.

Although the remote devices are connected, their connectivity is normally restricted to short range technologies, such as PC5, BlueTooth (BT), device-to-device (D2D), Proximity Services (ProSe), and so on, in order to help minimize power consumption. Even for remote devices that are capable of longer range communication, it is desirable to use short range technologies instead because such technologies typically consume less power than long range technologies. Therefore, in order to remotely located devices and/or services, an intermediary device is needed to relay communications to and from the remote devices.

### SUMMARY OF THE DISCLOSURE

Example embodiments provide a system and method for device identification and authentication.

In accordance with an example embodiment, a method for providing relay services to a remote device (RD) of a communications system is provided. The method includes receiving, by a relay device, a relay service request from the RD, the relay service request including at least an identifier of the RD, and the RD is not in active radio communications with an entity of the communications system, restricting, by the relay device, relay services on communications from the RD, sending, by the relay device, a first authentication request including at least a portion of the relay service request to a network node, receiving, by the relay device, a second authentication response confirming the identity of the RD, and unrestricting, by the relay device, the relay services on communications from the RD.

In accordance with another example embodiment, a relay device adapted to provide relay services to a remote device (RD) of a communications system is provided. The relay device includes a processor, and a computer readable storage medium storing programming for execution by the processor. The programming including instructions to configure the relay device to receive a relay service request from the RD, the relay service request including at least an identifier of the RD, and the RD is not in active radio communications with an entity of the communications system, restrict relay services on communications from the RD, send a first authentication request including at least a portion of the relay service request to a network node, receive a second authentication response confirming the identity of the RD, and unrestrict the relay services on communications from the RD.

In accordance with another example embodiment, a non-transitory computer-readable medium storing programming for execution by a processor is provided. The programming including instructions to receive a relay service request from a remote device (RD), the relay service request including at least an identifier of the RD, and the RD is not in active radio communications with an entity of a communications system including the RD, restrict relay services on communications from the RD, send a first authentication request including at least a portion of the relay service request to a network node, receive a second authentication response confirming the identity of the RD, and unrestrict the relay services on communications from the RD.

Practice of the foregoing embodiments enables a relay device to be informed regarding the identification and authentication of a remote device that it is relaying so that it can continue or discontinue relaying traffic for the remote device.

### BRIEF DESCRIPTION OF THE DRAWINGS

For a more complete understanding of the present disclosure, and the advantages thereof, reference is now made to the following descriptions taken in conjunction with the accompanying drawing, in which:

FIG. 1 illustrates an example wireless communications system according to example embodiments described herein;

FIG. 2 illustrates an example communications system highlighting the distribution of information related to an RD and a relay UE as the relay UE provides relay services for the RD according to example embodiments described herein;

FIG. 3 illustrates a message exchange diagram of messages exchanged and processing occurring in a communications system highlighting an initiating of relay services according to example embodiments described herein;

FIG. 4 illustrates a message exchange diagram of messages exchanged and processing occurring in a communications system highlighting a first direct path solution for an initiating of relay services according to example embodiments described herein;

FIG. 5 illustrates a message exchange diagram of messages exchanged and processing occurring in a communications system highlighting a first direct path solution for an initiating of relay services according to example embodiments described herein;

FIG. 6 illustrates a flow diagram of example operations occurring at an RD participating in the configuration of communications for the RD according to example embodiments described herein;

FIG. 7 illustrates a flow diagram of example operations occurring at a relay UE participating in the configuration of communications for an RD according to example embodiments described herein;

FIG. 8 illustrates a flow diagram of example operations occurring in an entity of a core network participating in the configuration of communications for a RD according to example embodiments described herein;

FIG. 9 illustrates a message exchange diagram of messages exchanged and processing occurring in a communications system highlighting an authentication based technique for initiating relay services according to example embodiments described herein;

FIG. 10 illustrates an example communications system highlighting parameter values and processing occurring at a relay UE, an RD, and a MME/HSS according to example embodiments described herein;

FIG. 11 illustrates a flow diagram of example operations occurring in an RD participating in the configuration of communications for the RD highlighting a technique that includes temporarily trusting the identity of the RD prior to authentication according to example embodiments described herein;

FIG. 12 illustrates a flow diagram of example operations occurring in a relay UE participating in the configuration of communications for a RD highlighting a technique that includes temporarily trusting the identity of the RD prior to authentication according to example embodiments described herein;

FIG. 13 illustrates a flow diagram of example operations occurring in an eNB participating in the configuration of communications for a RD highlighting a technique that includes temporarily trusting the identity of the RD prior to authentication according to example embodiments described herein;

FIG. 14 illustrates a flow diagram of example operations occurring in an entity of a core network participating in the configuration of communications for a RD highlighting a technique that includes temporarily trusting the identity of the RD prior to authentication according to example embodiments described herein;

FIG. 15 illustrates a message exchange diagram of messages exchanged and processing occurring in a communications system highlighting a technique that includes temporarily trusting the identity of the RD prior to authentication according to example embodiments described herein;

FIG. 16 illustrates a message exchange diagram of messages exchanged and processing occurring in a communications system highlighting a UE context exchange included in a TAU message in a relay service request according to example embodiments described herein;

FIG. 17 illustrates a message exchange diagram of messages exchanged and processing occurring in a communications system highlighting a UE context exchange triggered during RD authentication according to example embodiments described herein;

FIG. 18 illustrates a message exchange diagram of messages exchanged and processing occurring in a communications system highlighting a relay service request including an identifier covering a RD according to example embodiments described herein;

FIG. 19 illustrates a block diagram of an embodiment processing system for performing methods described herein; and

FIG. 20 illustrates a block diagram of a transceiver adapted to transmit and receive signaling over a telecommunications network.

### DETAILED DESCRIPTION OF ILLUSTRATIVE EMBODIMENTS

The operating of the current example embodiments and the structure thereof are discussed in detail below. It should be appreciated, however, that the present disclosure provides many applicable inventive concepts that can be embodied in a wide variety of specific contexts. The specific embodiments discussed are merely illustrative of specific structures of the embodiments and ways to operate the embodiments disclosed herein, and do not limit the scope of the disclosure.

One embodiment relates to systems and methods for device identification and authentication. For example, a relay device receives a relay service request from the RD, the relay service request including at least an identifier of the RD, and the RD is not in active radio communications with an entity of the communications system, restricts relay services on communications from the RD, sends a first authentication request including at least a portion of the relay service request to a network node, receives a second authentication response confirming the identity of the RD, and unrestricts the relay services on communications from the RD.

The embodiments will be described with respect to example embodiments in a specific context, namely communications systems that support relaying communications for remote devices (RDs). The embodiments may be applied to standards compliant communications systems, such as those that are compliant with Third Generation Partnership Project (3GPP), IEEE 802.11, and the like, technical standards, and non-standards compliant communications systems, that support relaying communications for RDs.

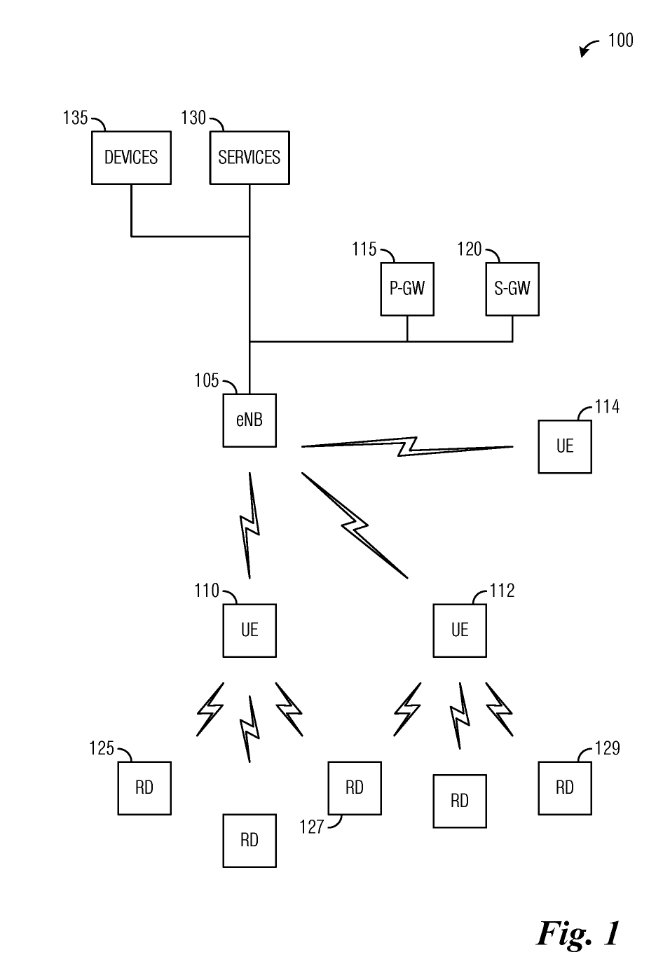

FIG. 1 illustrates an example wireless communications system 100. Wireless communications system 100 includes an evolved Node B (eNB) 105 serving a plurality of user equipments (UEs), such as UE 110, UE 112, and UE 114. In a cellular operating mode, communications to and from the plurality of UEs go through eNB 105, while in machine to machine communications mode, such as proximity services (ProSe) operating mode, for example, direct communication between UEs is possible. eNBs may also be commonly referred to as Node Bs, controllers, base stations, access points, and so on, while UEs may also be commonly referred to as mobile stations, mobiles, terminals, users, subscribers, stations, and the like. Communications from an eNB to a UE are commonly referred to as downlink communications, while communications from a UE to an eNB are commonly referred to as uplink communications.

Wireless communications system 100 also includes network entities such as a packet data network gateway (PDN gateway or P-GW) 115 that provides interconnectivity between networks, and a serving gateway (S-GW) 120 that provides entry and egress points for packets intended for users. Wireless communications system 100 also includes a plurality of remote devices (RDs), such as RD 125, RD 127, and RD 129. The plurality of RDs may include sensor devices, wearable devices, smart appliances, and so on. While it is understood that communications systems may employ multiple eNBs capable of communicating with a number of UEs and RDs, only one eNB, a number of UEs, and a number of RDs are illustrated for simplicity.

As discussed previously, the RDs typically have limited connectivity options in terms of range. As an example, due to power consumption considerations, it is likely that many RDs will not have medium to long range wireless connectivity, such as 3GPP LTE, longer-range IEEE 802.11 WiFi technologies, code division multiple access (CDMA), and the like, connectivity. Further, even RDs that do support a longer range communications technology may experience degraded link budgets compared to typical longer-range devices such as smartphones, due to restrictions on power consumption and/or radio performance. Therefore, UEs in a wireless communications system may serve as relays to relay communications to and from the RDs. UEs may connect to RDs over short range connectivity, such as PC5, BlueTooth, ProSe, shorter-range IEEE 802.11 WiFi technologies, D2D, and so on, connections, and forward packets between the RDs and remotely located services and/or devices. The UEs providing relay services may be referred to as relay UEs. As an illustrative example, UE 110 serves as a relay for RD 125 and RD 127, while UE 112 serves as a relay for RD 127 and RD 129, providing connectivity between the RDs and remotely located services 130 and/or devices 135 by way of eNB 105.

A relay UE may provide relay services for one or more RDs, receiving packets from the RDs and forwarding the received packets to the eNB serving the relay UE or receiving packets from the eNB serving the UE and forwarding the received packets to respective RDs. The number of RDs supported by a single relay UE may grow quickly. As an example, a relay UE is expected to relay packets for RDs owned by the owner of the UE, including a smart watch, smart glasses, a fitness or activity tracker, and so on. The relay UE may also relay packets for other RDs that it may encounter throughout the day. The relay UE may use a separate data radio bearer (DRB) for each RD.

In many cases, the RD and the relay UE will belong to the same owner and no special permission is needed for the RD to use the relay services of the relay UE. However, there may be some situations in which a relay UE may be willing to relay traffic for RDs owned by others. As an illustrative example, the RD may be owned by a family member. As another illustrative example, an operator of the communications system may offer a “reverse billing” incentive, wherein the owner of the relay UE may receive incentives, such as service credits, bandwidth credits, and the like, when the relay UE provides relay services to RDs owned by others. In such situations, some form of consent from the owner of the relay UE is required before the RD is admitted into relay service.

However, when the RD and the relay UE first make contact over a direct interface, the relay UE only has the word of the RD with regard to the identity of the RD. At some point, the identity of the RD should be confirmed through authentication with the communications system, e.g., the core network. Although the authentication procedure authenticates the identity of the RD as provided to the core network, existing authentication procedures do not inform the relay UE of the authentication result (i.e., the outcome). In practice, the relay UE needs to be informed of the authentication result so that it can confirm or deny if the original admission decision regarding the RD is correct. Furthermore, there should be confirmation that the same identity is used in both procedures (RD identity confirmation at the relay UE and RD authentication at the core network), i.e., the RD should not be allowed to announce a first identity to the relay UE and a second identity to the core network.

A baseline behavior may involve the relay UE accepting the announced identity of the RD and assuming that authentication at the core network will take care of verification. If authentication fails in such a situation, the core network will reject the attach request of the RD and the RD should stop attempting to attach. However, a number of problems exist with this approach, including:
The relay UE does not have insight into the non-access stratum (NAS) messaging between the RD and the core network, so the relay UE does not know about the authentication failure. Hence, the relay UE has no way to take the authentication result into account in its own internal state, e.g., updating a whitelist of RDs that it allows or a blacklist of RDs that it does not allow.
If there is a problem with the credentials of the RD (or if the RD is malicious), there is no way for the relay UE to prevent the RD from constantly retrying its relay requests. This is known as the “babbling idiot” problem. The core network can automatically reject the repeated authentication requests, but the relay UE does not know that this is occurring and may waste bandwidth and power by participating in the relay requests. If the relay UE knows that the RD has failed authentication at the core network, the relay UE can immediately throttle the relay request from the start, thus reducing the burden on its own resources and eliminating the burden on the network from the misbehaving RD.
There is no way to ensure that the RD presents the same identity to the relay UE and the core network. As an example, the RD can request relaying using a false identity (e.g., claim to be a RD belonging to the same owner as the relay UE) but when authenticating with the core network, the RD would use its own identity. This would be theft of service with regard to the relay UE, including possibly using the relay UE to transport malicious traffic.

In general, when a RD requests relay service from a relay UE, the relay UE (or an owner of the relay UE) should have control of whether to accept the relay request or not. Typically, the owner of the relay UE may allow access to only their own RDs, with a possibility of this acceptance occurring automatically. The owner may also elect to allow access to RDs owned by others. In some situations, the decision may be persistent or permanent in nature. As an illustrative example, RDs of family members and/or friends may be allowed access on a permanent basis. In other situations, the decision may be a one-time-only grant or only for a limited period of time.

As discussed previously, the RD requesting relay services from the relay UE would need to identify itself to the relay UE. However, the relay UE would need to know if the identification provided by the RD is accurate. In order to authenticate the identity of the RD, it is assumed that the RD has credentials (information used for authentication purposes) with respect to the core network, which in many cases may be its own subscription. The credentials may be associated with a subscription of the relay UE (e.g., in a situation if an owner owns both the RD and the relay UE). However, the authentication procedure should also work for RDs that are previously unknown to the relay UE.

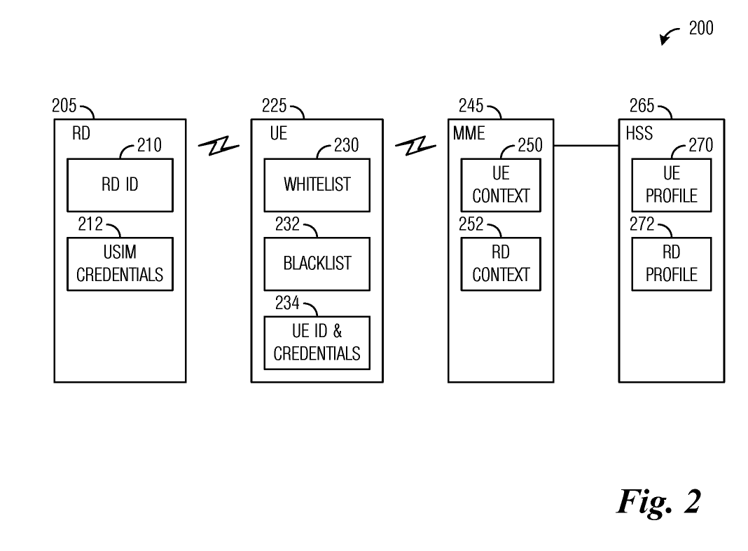

FIG. 2 illustrates an example communications system 200 highlighting the distribution of information related to an RD and a relay UE as the relay UE provides relay services for the RD. Communications system 200 includes an RD 205, a relay UE 225, a mobility management entity (MME) 245, and a home subscriber server (HSS) 265. At RD 205, the information includes an RD identifier (RD ID) 210 and universal subscriber identity module (USIM) credentials 212. RD ID 210 is an identifier that uniquely identifies RD 205, such as a medium access control address of RD 205 and USIM credentials 212 include information about RD 205 used for access authentication of RD 205. At relay UE 225, the information includes a whitelist 230, a blacklist 232, and a relay UE identifier (UE ID) and credentials 234. Whitelist 230 includes a list of RDs that relay UE 225 will provide relay services for and blacklist 232 includes a list of RDs that relay UE 225 will not provide relay services for. UE ID and credentials 232 includes information about relay UE 225 used for access authentication purposes.

At MME 245, the information includes relay UE context 250, which includes information about the session of relay UE 225, and potentially RD context 252, which includes information about the session state of RD 205 (if one exists). At HSS 265, the information includes relay UE profile 270, which includes information that impacts how relay UE 225 experiences services, and RD profile 272, which includes information that impacts how RD 205 experiences services.

As shown in FIG. 2, it is assumed that relay UE 225 and RD 205 are connected to the same HSS (i.e., HSS 265). If relay UE 225 and RD 205 are not connected to the same HSS, communications would include interaction with an appropriate home public land mobile network (HPLMN) for the RD. MME 245 may have the context for RD 205 (RD context 252) if RD 205 has an active core network attachment. It is noted that the active core network attachment may be through a different MME rather than through MME 245.

Communications between relay UE 225 and RD 205 may occur over a short-range radio access technology (RAT), such as PC5, BlueTooth, ProSe, shorter-range IEEE 802.11 WiFi technologies, D2D, and so on. The example embodiments presented herein are independent of the RAT used to provide relay UE 225 to RD 205 connectivity.

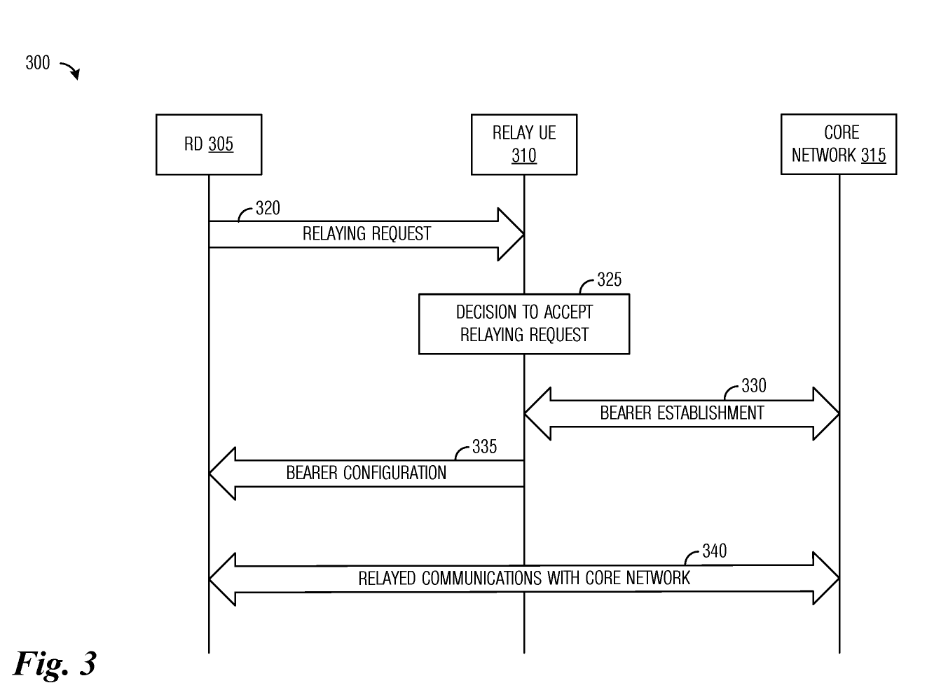

FIG. 3 illustrates a message exchange diagram 300 of messages exchanged and processing occurring in a communications system highlighting an initiating of relay services. Message exchange diagram 300 displays messages exchanged and processing occurring at an RD 305, a relay UE 310, and a core network 315. RD 305 sends a relaying request to relay UE 310 (shown as event 320). Relay UE 310 makes a decision to accept relaying requests (shown as event 325). Relay UE 310 may need to make the decision, referred to as an admission decision, based on information provided by RD 305 in the relaying request. However, relay UE 310 may be able to rescind the admission decision at a later time.

Relay UE 310 establishes radio bearers for RD 305 with core network 315 (shown as event 330). Relay UE 310 may not need to establish all of the data radio bearers (DRBs) needed to support relay services for RD 305. However, at least one S1 resource and signaling radio bearers (SRBs) are established by relay UE 310. Relay UE 310 sends configuration information about the radio bearers to RD 305 (shown as event 335). Relay UE 310 relays communications between RD 305 and core network 315 (shown as event 340). It is noted that the first opportunity for RD 305 to authenticate using existing techniques is during relayed communications, event 340.

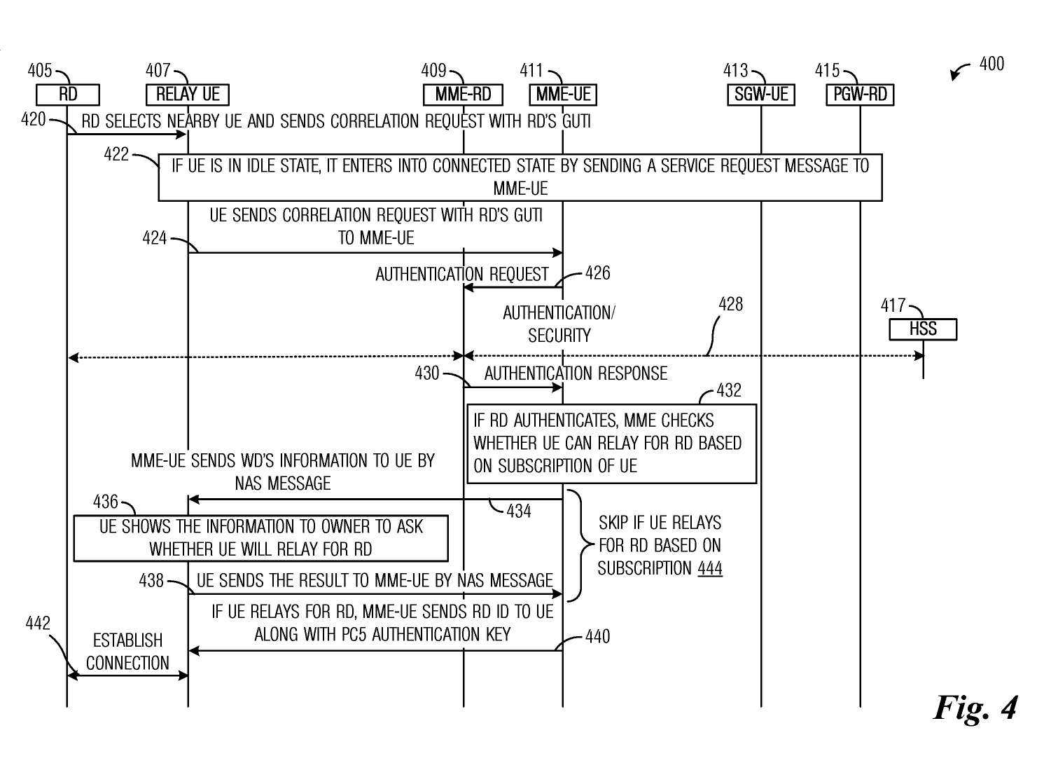

FIG. 4 illustrates a message exchange diagram 400 of messages exchanged and processing occurring in a communications system highlighting a first direct path solution for an initiating of relay services. Message exchange diagram 400 displays messages exchanged and processing occurring at a RD 405, a relay UE 407, MME for RD (MME-RD) 409, MME for relay UE (MME-UE) 411, serving gateway for relay UE (SGW-UE) 413, and PDN gateway for RD (PGW-RD) 415. The direct path refers to the presence of an existing connection between RD 405 and the core network (e.g., between RD 405 and PGW-RD 415) without relying on communication through a relay UE.

RD 405 selects a nearby relay UE (e.g., relay UE 407) and sends a correlation request with the globally unique temporary ID (GUTI) of RD 405 (event 420). The correlation request is an example of a request to authenticate the identity of a device, in this case, RD 405. If relay UE 407 is in an idle state, relay UE 407 enters into a connected state by sending a service request message to MME-UE 411 (block 422). Relay UE 407 also sends (e.g., forwards) the correlation request with the GUTI of RD 405 to MME-UE 411 (event 424). MME-UE 411 sends an authentication request to MME-RD 409 (event 426). The authentication request is generated based on the correlation request. MME-RD 409 sends an authentication response to MME-UE 411 (event 428). The authentication request (event 426) and the authentication response (event 428) may be communicated over the air, but there may be no assurance that the communications will be successful.

Messages are exchanged between MME-RD 409 and HSS 417 to perform authentication and/or security checking for RD 405. It is noted that if RD 405 does not have a direct path connection to the core network, authentication of RD 405 (event 426) is not always possible. If MME-RD 409 cannot authenticate RD 405 (due to HSS 417 being unreachable, stale context in MME-RD 409, and so on, for example), the authentication of RD 405 may rely on an exchange of NAS messages between RD 405 and MME-UE 411. However, if MME-UE 411 has no context information for RD 405, the NAS messages cannot be delivered to or from RD 405. Even if MME-RD 409 and MME-UE 411 are actually a single device, there will be no S1 radio bearer for RD signaling towards relay UE 407.

If RD 405 is authenticated, MME-UE 411 checks to determine if relay UE 407 can provide relay services for RD 405 based on the subscription of relay UE 407 (block 432). If MME-UE 411 is unable to determine if relay UE 407 can provide relay services based on the subscription of relay UE 407, MME-UE 411 sends information about RD 405 to relay UE 407 (event 434). The information may be sent using a NAS message. Relay UE 407 displays the information about RD 405 to the owner to ask if relay UE 407 can relay for RD 405 (block 436). Relay UE 407 sends the response from the owner to MME-UE 411 (event 438). The response may be sent using a NAS message. It is noted that if relay UE 407 will relay for RD 405 based on the subscription of relay UE 407, event 434, block 436, and event 438 are not needed (shown as span 444). If relay UE 407 will provide relay services to RD 405, MME-UE 411 sends the identifier of RD 405 (RD ID) to relay UE 407, along with a PC5 authentication key (event 440). Relay UE 407 and RD 405 establish a connection (event 442).

However, the process just described does not account for the possibility that RD 405 requires an initial authentication in order to establish any context in the core network. Such a situation could occur, for examples, if RD 405 does not have wireless wide area network (WWAN) access, either due to a lack of supporting hardware (e.g., if it is a Bluetooth-only device) or due to being outside of cellular coverage. In this situation, RD 405 needs to exchange information with HSS 417 in order to authenticate, but RD 405 is unable to do so without WWAN access. Further aspects described below show how this problem may be addressed.

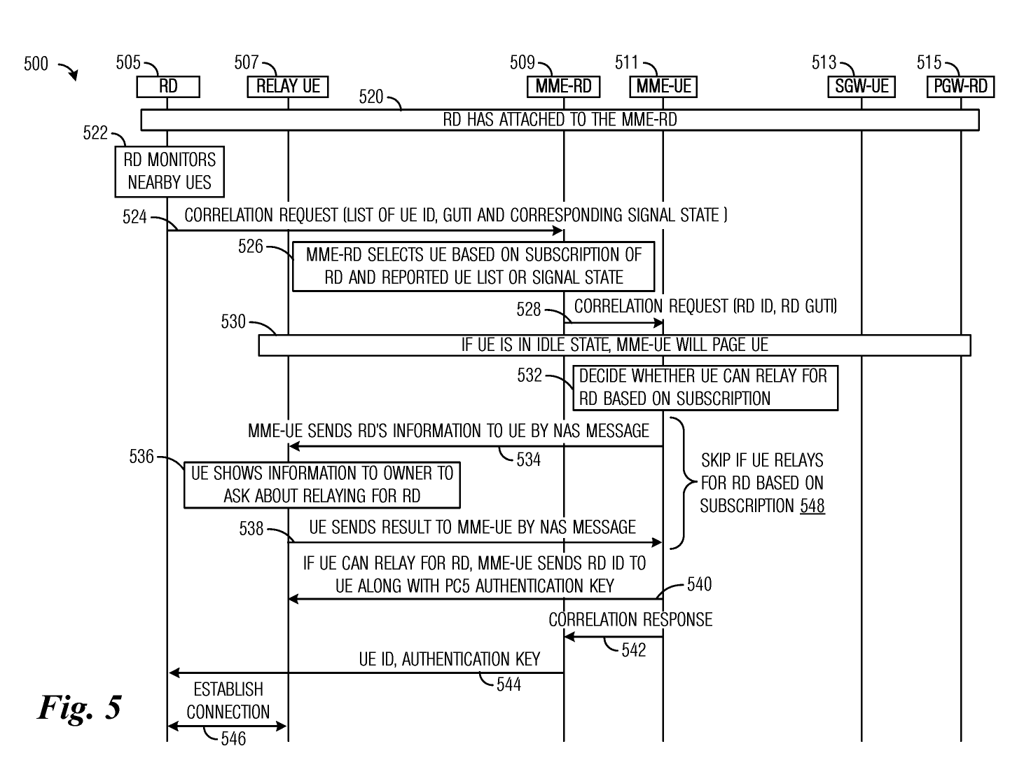

FIG. 5 illustrates a message exchange diagram 500 of messages exchanged and processing occurring in a communications system highlighting a first direct path solution for an initiating of relay services. Message exchange diagram 500 displays messages exchanged and processing occurring at RD 505, relay UE 507, MME-RD 509, MME-UE 511, SGW-UE 513, and PGW-RD 515.

As shown in FIG. 5, RD 505 is attached to MME-RD 509 (block 520). As part of becoming attached to MME-RD 509, RD 505 has been authenticated, which may include the requirements discussed previously (e.g., involves a direct path or a new authentication procedure, and how will RD 505 authenticate the very first time?). RD 505 monitors nearby relay UEs (block 522). RD 505 may measure signal strengths of signals transmitted by nearby relay UEs, for example. RD 505 may additionally monitor information signaled from nearby UEs in order to determine which of them may offer relaying as a service, e.g., service discovery signaling messages. RD 505 sends a correlation request with a list of relay UE IDs, the GUTI of RD 505, and a corresponding signal state to MME-RD 509 (event 524). MME-RD 509 selects an ID (and a relay UE associated with the ID) from the list of relay UE IDs (block 526). The selection of the ID may be in accordance with subscriptions of the relay UEs and subscription of RD 505, as well as signal states, for example.

MME-RD 509 sends a correlation request (which may be the correlation request received in event 524 or a message derived from information in the correlation request received in event 524, e.g., the correlation request sent by MME-RD 509 indicates the selected relay UE ID as well as the RD GUTI) to MME-UE 511 (event 528). If relay UE 507 is in an idle state, MME-UE 511 pages relay UE 507 (block 530). MME-UE 511 checks to determine if relay UE 507 can provide relay services for RD 505 based on the subscription of relay UE 507 (block 532). If MME-UE 511 is unable to determine if relay UE 507 can provide relay services based on the subscription of relay UE 507, MME-UE 511 sends information about RD 505 to relay UE 507 (event 534). The information may be sent using a NAS message. Relay UE 507 displays the information about RD 505 to the owner to ask if relay UE 507 can relay for RD 505 (block 536). Relay UE 507 sends the response from the owner to MME-UE 511 (event 538). The response may be sent using a NAS message. It is noted that if relay UE 507 will relay for RD 505 based on the subscription of relay UE 507, event 534, block 536, and event 538 are not needed (shown as span 548).

If relay UE 507 will provide relay services for RD 505, MME-UE 511 sends the identifier of RD 505 (RD ID) to relay UE 507, along with a PC5 authentication key (event 540). MME-UE 511 sends a correlation response to MME-RD 509 (event 542). MME-RD 509 sends the identifier of relay UE 507 (UE ID) and an authentication key to RD 505 (event 544). Relay UE 505 and RD 505 establish a connection (event 546).

As shown in FIG. 5, NAS signaling in events 524 and 544 occur over the direct path since the path through relay UE 507 has not been established. Furthermore, MME-RD 509 does not have an S1 radio bearer towards relay UE 507, even if MME-RD 509 and MME-UE 511 was actually a single device. Even in such a situation, MME-RD 509 does not know where to send RD messaging. Additionally, the RD ID is presented to relay UE 507 by MME-UE 511 and not by RD 505. Therefore, the RD ID can be confirmed by MME-RD 509 using NAS integrity. MME-RD 509 may need to check that the GUTI sent by RD 505 matches the identity of RD 505. It is noted that this check is not an integrity check, which simply provides proof that the sender correctly signed the message; beyond the integrity check, MME-RD 509 may need to confirm the correct value of the message field containing the GUTI. Without direct path NAS signaling, no other device is able to verify the RD ID and there is no way to send the RD ID to MME-RD 509.

According to an example embodiment, the relay UE requires a cryptographic signature (CS) of the RD for authentication purposes. As an example, a CS is a message authentication code (MAC) computed by the RD. If the RD has not previously attached, the CS can be generated by the RD based on information available in the RD, for example, security credentials provisioned in the RD or stored in a secure module such as a USIM. The CS may be passed to the core network for authentication, which informs the relay UE of the authentication results. Until the RD has been authenticated, traffic from the RD is not accepted by the system. Preferably, traffic from an unauthenticated RD is stopped by the relay UE, rather than being delivered to the network and requiring further resources to process the traffic there.

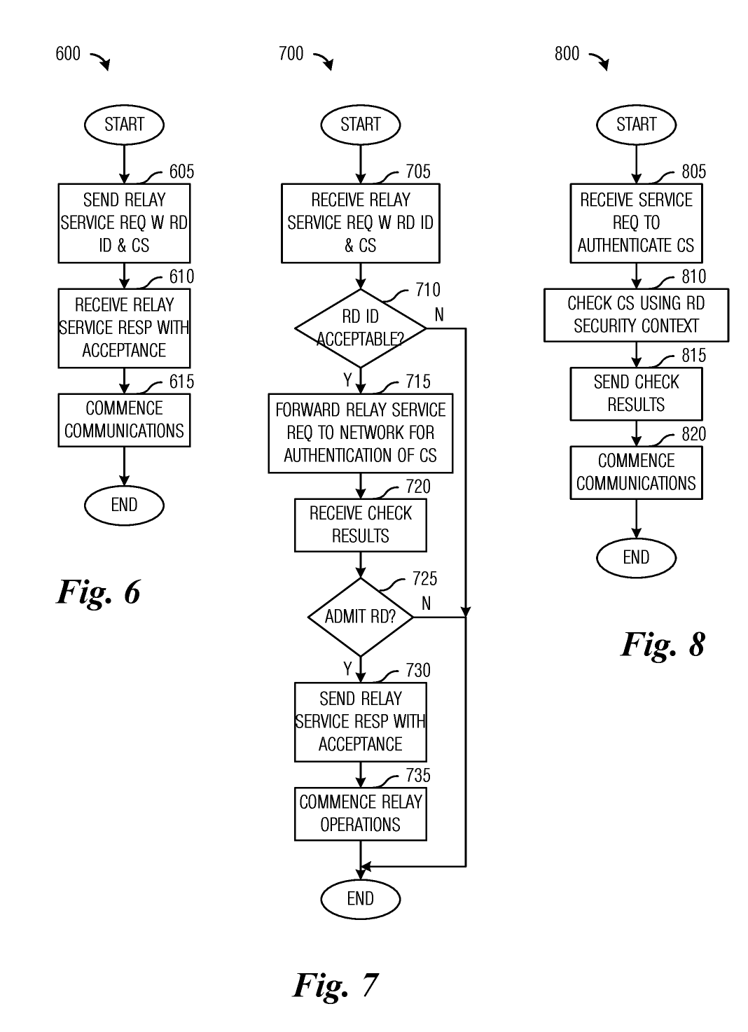

FIG. 6 illustrates a flow diagram of example operations 600 occurring at an RD participating in the configuration of communications for the RD. Operations 600 may be indicative of operations occurring at an RD, such as RD 125, RD 127, or RD 129, as the RD participating in the configuration of communications for the RD.

Operations 600 begin with the RD sending a relay service request to the relay UE (block 605). The relay service request includes an identifier of the RD (e.g., RD ID) and a CS of the RD. The relay service request optionally includes a freshness parameter, e.g., a nonce (a numerical value chosen so that repeated use of the same value is unlikely or impossible) to seed a cryptographic function to help prevent replay attacks. As an illustrative example, the CS is a MAC. Alternatively, the CS may be any encrypted sequence that covers the identifier of the RD. The RD ID indicates a MME associated with the RD, i.e., the MME-RD, if it is different from the MME-UE. An example of the RD ID is the GUTI of the RD. If there is no MME-RD or if the MME-RD does not support the RD authentication procedure, the RD may provide a permanent ID to be sent to the HSS. If the RD ID provided by the RD is associated with a MME-RD that does not support the RD authentication procedure, an error results. In other words, the RD needs to know whether its MME-RD supports the RD authentication procedure. The RD may determine to send a permanent ID (e.g., an international mobile subscriber identity (IMSI)) in place of a temporary ID associated with the MME-RD (e.g., a GUTI) in case the MME-RD does not support the RD authentication procedure.

For discussion purposes, it is assumed that the RD has a valid subscription that supports relay services, that the relay UE is permitted to offer relay service to the RD, and that the CS authenticates successfully. The RD receives a relay service response from the relay UE, the relay service response including an indication that the RD has been accepted (block 610). The RD commences communications (block 615). The RD communicates through the relay UE, with packets relayed to or from the RD by way of a short range connection with the relay UE.

FIG. 7 illustrates a flow diagram of example operations 700 occurring at a relay UE participating in the configuration of communications for an RD. Operations 700 may be indicative of operations occurring in a relay UE, such as relay UE 110 or relay UE 112, as the relay UE participating in the configuration of communications for the RD.

Operations 700 begin with the relay UE receiving a relay service request from the RD (block 705). The relay service request includes an identifier of the RD (e.g., RD ID) and a CS of the RD. The relay service request optionally includes a freshness parameter, which is also used in generating the CS. As an illustrative example, the freshness parameter may be a nonce generated at the RD. As an illustrative example, the CS is a MAC. Alternatively, the CS may be any encrypted sequence that covers the identifier of the RD.

The relay UE performs a check to determine if the RD ID is acceptable for relay service (block 710). As an illustrative example, the relay UE may have a whitelist of RDs that it will serve and/or a blacklist of RDs that it will not serve and the check to determine if the RD ID is acceptable makes use of the whitelist and/or the blacklist to help improve performance. The implementation of such a list by the relay UE may significantly reduce the complexity and time involved in configuring the relay services. For example, the relay UE may determine if the RD ID is acceptable by checking to see if the RD ID is in the whitelist (i.e., the RD ID is acceptable), the blacklist (i.e., the RD ID is not acceptable), or neither (i.e., the acceptability of the RD ID is undetermined and further procedures may be required to take a final decision on whether to offer relay service to the RD). It is noted that, depending upon implementation, even if the RD ID is acceptable (i.e., the RD ID is in the whitelist) the relay UE may still authenticate the RD. This may be necessary since it is possible for a malicious RD to provide a false RD ID. If the RD ID is not acceptable, the relay UE may simply refuse to proceed further with the process of providing relay services to the RD. The relay UE may also inform the core network that an RD on its blacklist is attempting to obtain relay services.

If the RD ID is acceptable (and CS authentication is desired) or if the RD ID is undetermined, the relay UE forwards the relay service request to the core network for CS authentication (block 715). Since the relay UE typically does not have all of the information needed to authenticate the CS, the relay UE forwards the relay service request to the core network to perform the CS authentication. As an illustrative example, the check to determine if the CS is valid may be performed using an S1-AP procedure involving an entity in the core network using the same input parameters used by the RD to generate the CS to generate a local version of the CS for comparison purposes. The input parameters include the RD ID, a key, and optionally, a freshness parameter. The relay service request includes the RD ID and optionally, the freshness parameter. The key may be provisioned to the RD on a permanent or long term basis. The key may be provisioned in the RD and the entity in the core network, such as the HSS. In general, a derived key is preferred over a permanently assigned key. Derivation of the key may use the identifier of the relay UE as input so that the key is specific to the RD-relay UE pair. The freshness parameter may be used to help prevent key repetition. The freshness parameter may be time based. Alternatively, the relay UE may pick an arbitrary value as a freshness parameter, which is unique for the RD-relay UE pair. The RD may provide a second freshness parameter, e.g., a second nonce, when it generates the CS for comparison.

The relay UE receives results of the CS authentication check from the core network (block 720). If the CS has not been authenticated successfully, the relay UE may add the RD ID to the blacklist and the relay UE may refuse to proceed further with the process of providing relay services to the RD. If the CS has been authenticated successfully, the relay UE performs a check to determine if the relay UE should admit the RD (block 725). As an illustrative example, the relay UE may query the owner of the relay UE to determine if the owner is agreeable to the relay UE providing relay services to the RD. As an alternative illustrative example, if the CS has been authenticated and if the RD is in the whitelist, the RD will be admitted without having to query the owner for permission. Alternatively, if the RD has been authenticated and if the RD is not in the whitelist, the relay UE may query the owner regarding providing relay services for the RD. If the RD has been admitted, the relay UE sends a relay service response to the RD, the relay service response includes an indication that the relay UE agrees to provide relay services to the RD (block 730). Once the relay services are setup, the RD can immediately begin sending and/or receiving traffic. The relay UE commences to relay traffic to and from the RD (block 735).

FIG. 8 illustrates a flow diagram of example operations 800 occurring in an entity of a core network participating in the configuration of communications for a RD. Operations 800 may be indicative of operations occurring in an entity of a core network, such as a MME or a HSS, as the entity of the core network participates in the configuration of communications for the RD.

The entity of the core network receives a relay service request from a relay UE (block 805). The relay service request includes an identifier of the RD (e.g., RD ID) and a CS of the RD. Optionally, the relay service request includes a freshness parameter. The entity of the core network checks the CS using the security context of the RD and the information included in the relay service request (block 810). As an illustrative example, the entity of the core network uses an S1-AP procedure (the CS authenticate procedure) to generate a local CS in accordance with the RD ID, a key associated with the RD, and optionally the freshness parameter. The entity of the core network compares the local CS with the CS included in the relay service request. If they match, the CS is authenticated. If they do not match, the CS is not authenticated. The CS authenticate procedure may be performed in the HSS or in the MME-RD if the parameters are provided to the MME-RD.

The entity of the core network sends results of the CS authentication check to the relay UE (block 815). For discussion purposes, it is assumed that the CS authenticates successfully. The entity of the core network commences communications with the RD via the relay UE (block 820).

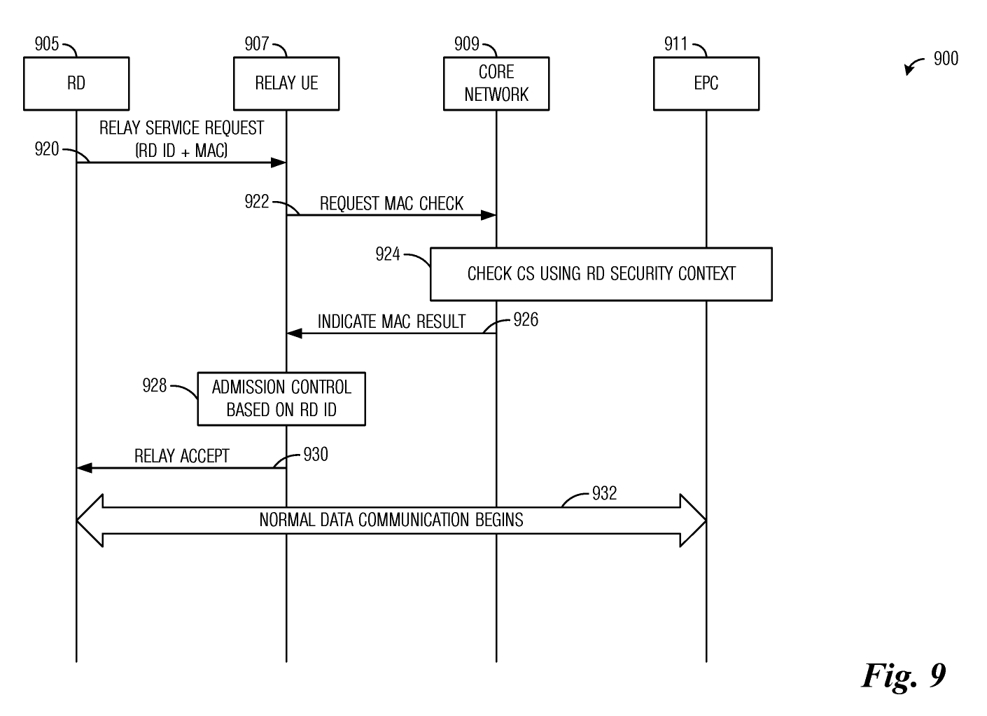

FIG. 9 illustrates a message exchange diagram 900 of messages exchanged and processing occurring in a communications system highlighting an authentication based technique for initiating relay services. Message exchange diagram 900 displays messages exchanged and processing occurring at a RD 905, a relay UE 907, core network 909, and an evolved packet core (EPC) 911. Core network 909 includes at least a MME (possibly different MMEs for RD 905 and relay UE 907) and a HSS.

RD 905 sends a relay service request to relay UE 907 (event 920). The relay service request includes an RD ID associated with RD 905, a CS generated by RD 905, and optionally, a freshness parameter. Relay UE 907 requests a MAC check (i.e., CS authentication) by core network 909 (event 922). Relay UE 907 sends the CS and the RD ID (and optionally, the freshness parameter) in the request. Core network 909 authenticates the CS in accordance with the RD ID (and optionally, the freshness parameter) provided in the request with respect to the security context of the RD (block 924). Core network 909 may use the CS authenticate procedure discussed previously. Core network 909 uses the CS authenticate procedure and the RD ID, the key (previously provisioned), and optionally, the freshness parameter, to generate a local CS. Core network 909 compares the local CS with the CS received in the relay service request and if they match, the CS is authenticated and if they do not match, the CS is not authenticated. Core network 909 sends the result of the MAC check (i.e., CS authentication) to relay UE 907 (event 926). Relay UE 907 performs admission control if the CS (and hence, RD 905) has been authenticated (block 928). Admission control may include prompting the owner of relay UE 907 for permission. Alternatively, if RD 905 is in the whitelist, admission control may be automatic if RD 905 passed authentication. Relay UE 907 sends a response message indicating that relay UE 907 accepts relaying for RD 905 (event 930). Normal communications involving RD 905 begins (event 932).

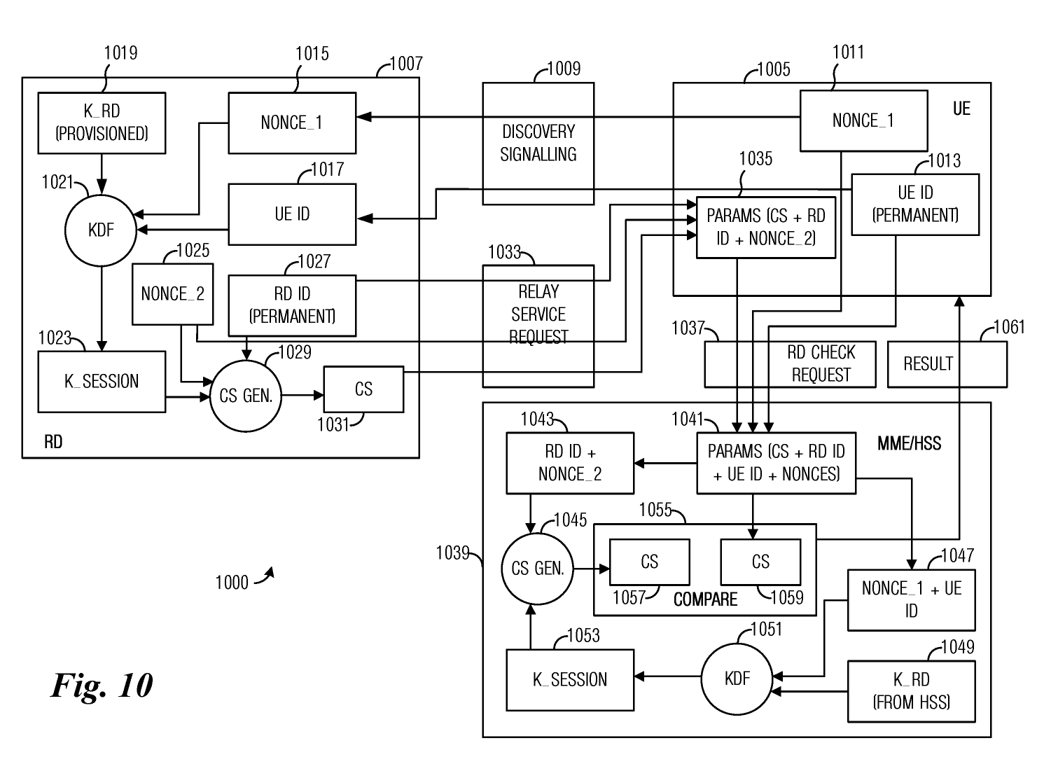

FIG. 10 illustrates an example communications system 1000 highlighting parameter values and processing occurring at a relay UE 1005, an RD 1007, and a MME/HSS 1039. Relay UE 1005 has a first freshness parameter (which is shown as a first nonce (NONCE_1)) 1011 and a UE identifier (UE ID) 1013 stored in a memory. During a discovery process, first freshness parameter 1011 and UE ID 1013 are exchanged with RD 1007 by way of discovery signaling 1009, resulting in RD 1007 storing copies of the first freshness parameter (in first nonce 1015) and the UE ID (in UE ID 1017) in a memory. RD 1007 may utilize a key derivation function (KDF) 1021 and a key (K_RD) 1019 provisioned by a HSS, for example, along with first nonce 1015 and UE ID 1017 to generate a session key (K_SESSION) 1023. A CS generator 1029 generates a CS 1031, e.g., a MAC, in accordance with session key 1023, a second freshness parameter (which is shown as a second nonce (NONCE_2) 1025, and an RD identifier (RD ID) 1027.

RD 1007 sends a relay service request 1033 to relay UE 1005. Relay service request 1033 includes RD ID 1027, CS 1031, and optionally second nonce 1025, which are stored by relay UE 1005 in the memory as first parameters 1035. Relay UE 1005 requests an RD check by MME/HSS 1039 by sending an RD check request 1037 to MME/HSS 1039. RD check request 1037 includes first parameters 1035 (CS 1031, RD ID 1027, second nonce 1025), first nonce 1011, and UE ID 1013, which are stored in a memory as second parameters 1041. RD check request 1037 may result in MME/HSS 1039 performing a CS authentication procedure with values stored in second parameters 1041. The CS authentication procedure may include MME/HSS 1039 using a KDF 1051 to generate a session key 1053 with parameters first nonce and UE ID 1047 along with the key for RD 1007 provisioned by the HSS (K_RD) 1049. A CS generator 1045 generates a local CS (stored in local CS 1057) using session key 1053 and the RD ID and the second nonce 1043 from second parameters 1041. A comparator 1055 compares the local CS in local CS 1057 with the CS from second parameters 1041 (stored in CS 1059), and provides the results of the comparison to UE 1005.

According to an example embodiment, the relay UE temporarily trusts that the RD has provided a good identity, i.e., an identity matching the RD ID used for authentication between the RD and the core network, but subsequently verifies the identity of the RD to ensure that the identity provided by the RD is good. Until the identity of the RD has been verified, the relay UE does not relay messages from the RD, with the exception of the authentication messages. As an illustrative example, when the relay UE receives the relay service request from the RD, the relay UE temporarily trusts the identity provided by the RD and starts admission control. The relay UE relays messages exchanged regarding the authentication procedure, but does not relay other messages. As an example, the relay UE relays an authentication request message to the RD and an authentication response message from the RD but does not relay any other messages until or unless the RD is successfully authenticated.

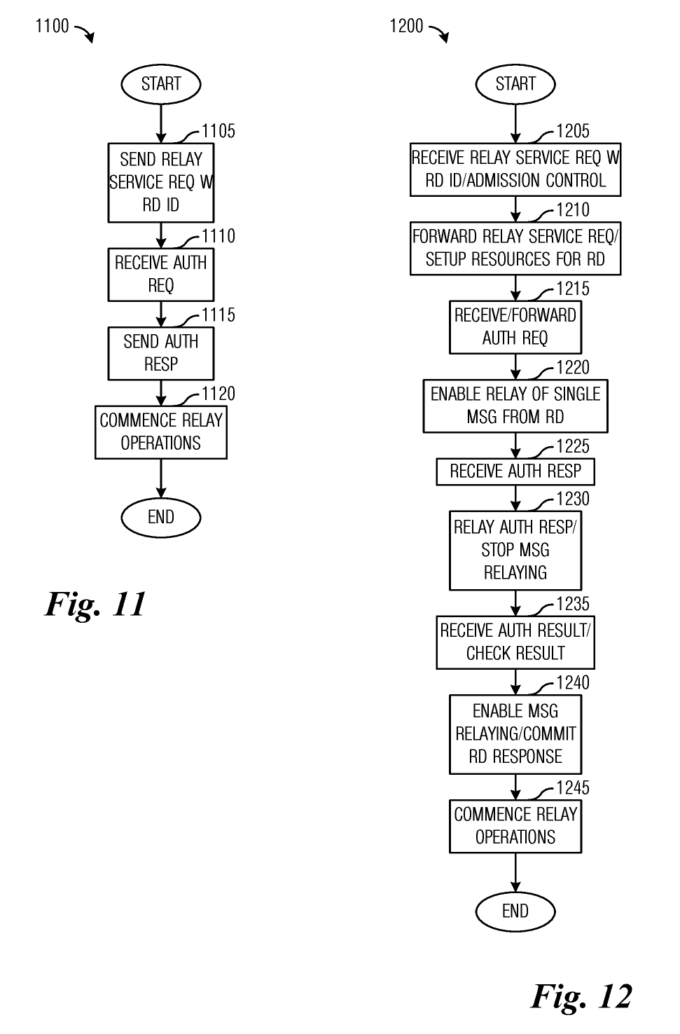

FIG. 11 illustrates a flow diagram of example operations 1100 occurring in an RD participating in the configuration of communications for the RD highlighting a technique that includes temporarily trusting the identity of the RD prior to authentication. Operations 1100 may be indicative of operations occurring in an RD as the RD participates in the configuration of communications for the RD highlighting a technique that temporarily trusts the identity of the RD prior to authenticating the identity of the RD.

Operations 1100 begin with the RD sending a relay service request with an identifier of the RD (RD ID, for example) to the relay UE (block 1105). The RD receives an authentication request from the relay UE (block 1110). The RD sends back an authentication response to the relay UE (block 1115). The authentication request and the authentication response may be standard authentication messages exchanged during an authentication procedure, such as those exchanged in the authentication and key agreement (AKA) procedures used in various cellular systems such as LTE and UMTS. The authentication request may have originated from an entity of the core network, such as a MME or a HSS. After the authentication request is forwarded to the RD, the relay UE permits the RD to send a single message, the authentication response. All other messages from the RD to other destinations through the relay UE are blocked. Once the authentication procedure completes successfully, relay operation commences with messages to and from the RD being relayed by the relay UE (block 1120).

FIG. 12 illustrates a flow diagram of example operations 1200 occurring in a relay UE participating in the configuration of communications for a RD highlighting a technique that includes temporarily trusting the identity of the RD prior to authentication. Operations 1200 may be indicative of operations occurring in a relay UE as the relay UE participates in the configuration of communications for the RD highlighting a technique that temporarily trusts the identity of the RD prior to authenticating the identity of the RD.

Operations 1200 begin with the relay UE receiving a relay service request from the RD (block 1205). The relay service request includes an identifier of the RD, e.g., RD ID. The relay UE also performs admission control for the UE (block 1205). Admission control may include the relay UE checking the RD ID provided by the RD with information in a whitelist of acceptable RDs and/or a blacklist of unacceptable RDs. If the RD ID is in the whitelist or not in the blacklist, the relay UE may also prompt an owner of the relay UE to ask for confirmation regarding the relay UE providing relay services to the RD. The response from the owner may be remembered but the whitelist and/or blacklist is not yet updated. Admission control may also include the relay UE checking its own subscription and/or permission information to determine if it can provide relay services to the RD. There may also be radio access technology dependencies, e.g., with PC5, eNB permissions may be needed, but not so for BlueTooth.

If the RD passes admission control, the relay UE forwards the relay service request (block 1210). The relay service request may be forwarded to an eNB serving the relay UE, which then sends the relay service request to an entity of the core network, such as a MME or a HSS. The relay service request may be sent to the eNB by the relay UE in the form of a new message that encapsulates an INITIAL UE MESSAGE. The relay UE receives an authentication request (block 1215). The authentication request may be in a NAS message from the entity of the core network. The forwarding of the relay service request and the receiving of the authentication request may result in the allocation of resources for the RD, e.g., an S1 bearer for the RD, as identified by an eNB S1AP UE ID. The relay UE forwards the authentication request to the RD (block 1215).

After the relay UE forwards the authentication request to the RD, the relay UE enables the relaying of a single message from the RD (block 1220). The single message that the relay UE will relay for the RD prior to the authentication of the RD may be the authentication response, which is the response of the RD to the authentication request that the relay UE forwarded to the RD. The relay UE receives the authentication response from the RD (block 1225). The relay UE relays the authentication response and stops the relaying of any other messages from the RD until the RD is authenticated (block 1230). It is noted that although the relay UE provisionally trusts the RD, the relay UE will not relay any messages from the RD until the relay UE receives the authentication request from the entity of the core network (e.g., the MME or HSS) and thereafter will only relay a single message (i.e., the authentication response) from the RD.

The relay UE receives an authentication result and checks the authentication result (block 1235). The authentication result may be received from the entity of the core network and may include the identity of the RD. The relay UE checks the identity of the RD as provided in the authentication result against the identity of the RD as provided by the RD in the relay service request received from the RD. If the identities match, the relay UE enables relay services for the RD and commits the RD response (block 1240). The relay UE may update the whitelist and/or blacklist, as well as taking into account the response of the owner of the relay UE if one was received. Relay operations commence (block 1245).

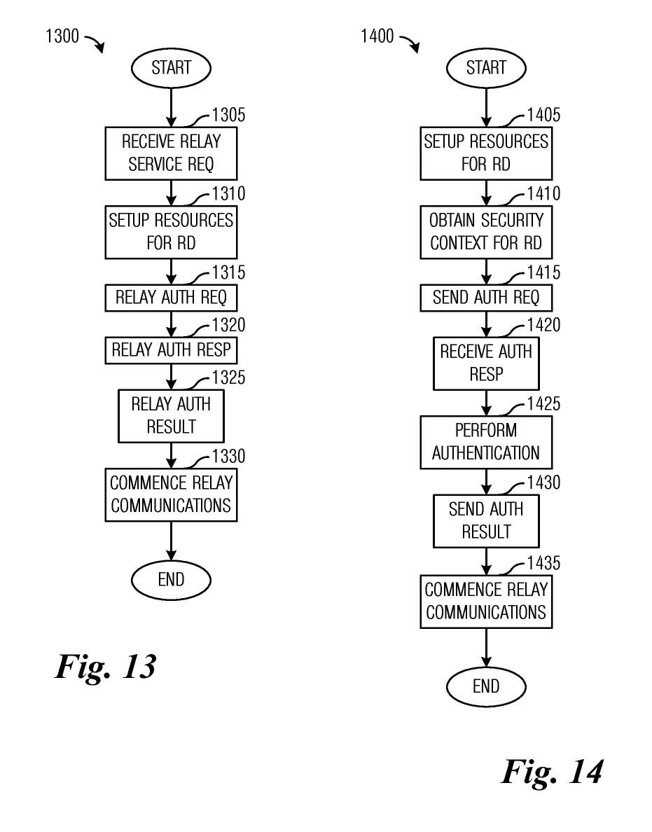

FIG. 13 illustrates a flow diagram of example operations 1300 occurring in an eNB participating in the configuration of communications for a RD, highlighting a technique that includes temporarily trusting the identity of the RD prior to authentication. Operations 1300 may be indicative of operations occurring in an eNB as the eNB participates in the configuration of communications for the RD, highlighting a technique that temporarily trusts the identity of the RD prior to authenticating the identity of the RD.

Operations 1300 begin with the eNB receiving relay service request from a relay UE (block 1305). The relay service request may be received in the form of a new message that encapsulates an INITIAL UE MESSAGE. The eNB participates in the setup of resources for the RD (block 1310). The eNB may participate in the setup of an S1 bearer for the RD. The eNB relays an authentication request from an entity of a core network, such as a MME or HSS (block 1315). The authentication request is relayed to the RD through the relay UE. The eNB relays the authentication response (block 1320). The eNB receives the authentication response from the RD through the relay UE and forwards the authentication response to the entity of the core network. The eNB relays an authentication result (block 1325). Relay communications commences (block 1330).

FIG. 14 illustrates a flow diagram of example operations 1400 occurring in an entity of a core network participating in the configuration of communications for a RD, highlighting a technique that includes temporarily trusting the identity of the RD prior to authentication. Operations 1400 may be indicative of operations occurring in an entity of a core network, such as a MME or HSS, as the entity of the core network participates in the configuration of communications for the RD, highlighting a technique that temporarily trusts the identity of the RD prior to authenticating the identity of the RD.

Operations 1400 begin with the entity participating in the setup of resources for the RD (block 1405). The entity and an eNB serving the relay UE may set up an S1 bearer for the RD. As a result of the resources setup, an eNB S1AP UE ID is established, which allows for the routing of NAS messages from the entity to the eNB. The entity obtains a security context for the RD (block 1410). The entity may obtain the security context from a HSS of the RD, for example. The entity sends an authentication request to the RD through the relay UE (block 1415). The authentication request may be sent to the relay UE in a NAS message that is routed using the resources setup for the RD. The entity receives an authentication response from the RD through the relay UE (block 1420). The authentication response may be received in a NAS message that is routed using the resources setup for the RD. The entity authenticates the RD in accordance with information contained in the authentication response (block 1425). The entity sends the results of the authentication (block 1430). Relay communications commences (block 1435).

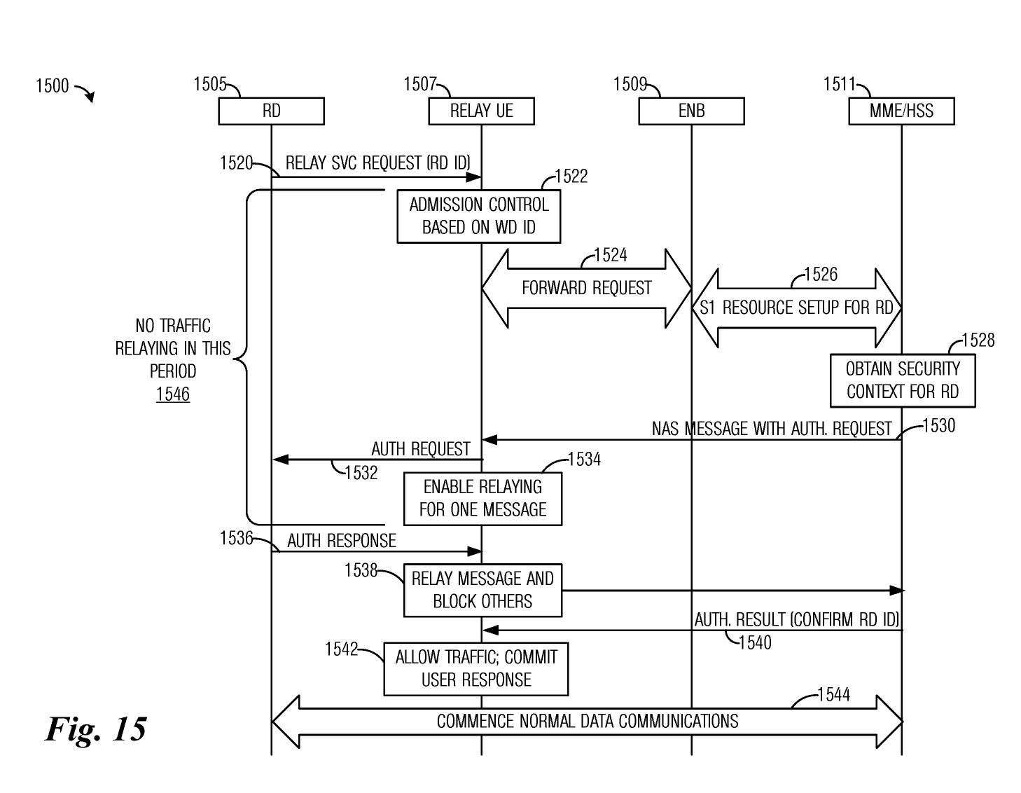

FIG. 15 illustrates a message exchange diagram 1500 of messages exchanged and processing occurring in a communications system, highlighting a technique that includes temporarily trusting the identity of the RD prior to authentication. Message exchange diagram 1500 displays messages exchanged and processing occurring at a RD 1505, a relay UE 1507, core network 1509, and a MME/HSS 1511.

RD 1505 sends a relay service request to relay UE 1507 (event 1520). The relay service request includes an identifier of the RD, e.g., RD ID. Relay UE 1507 performs admission control based on the RD ID (block 1522). Admission control may include comparing the RD ID to information in a whitelist and/or blacklist, prompting an owner of relay UE 1507, checking the subscription and/or permission of relay UE 1507, and so on. Relay UE 1507 forwards the relay service request to eNB 1509 (event 1524). The relay service request may be forwarded in the form of a new message that encapsulates an INITIAL UE MESSAGE. eNB 1509 sets up resources for RD 1505 (event 1526). The resources for RD 1505 are setup through messages exchanged between eNB 1509 and MME/HSS 1511. In addition to setting up resources for RD 1505, MME/HSS 1511 also obtains a security context for RD 1505 (block 1528). As an example, the security context for RD 1505 is obtained from HSS.

MME/HSS 1511 sends an authentication request to RD 1505 through relay UE 1507 (event 1530). The authentication request may be sent in a NAS message to relay UE 1507. Relay UE 1507 forwards the authentication request to RD 1505 (event 1532). Relay UE 1507 enables relaying for one message (block 1534). As an example, the one message that relay UE 1507 will relay is an authentication response that corresponds to the authentication request. During a period 1546 spanning admission control (block 1522) to enable relaying (block 1534), relay UE 1507 relays no traffic for RD 1505. RD 1505 sends an authentication response to relay UE 1507 (event 1536). Relay UE 1507 relays the authentication response to MME/HSS 1511 while blocking any other message to or from RD 1505 (block 1538). MME/HSS 1511 performs authentication using information provided by RD 1505 in the authentication response and sends the results of the authentication to relay UE 1507 (event 1540). Relay UE 1507 may be able to determine that the authentication request and the results of the authentication are related by examining a transaction identifier, for example. For discussion purposes, it is assumed that RD 1505 is authenticated, relay UE 1507 allows traffic relaying for RD 1505 and commits the response of the owner from admission control (block 1542). Communications commences (event 1544).

In a scenario when a MME associated with the relay UE (MME-UE) does not have a security context for the RD, some additional processing may be required. In a first case, if the RD provides an identifier that is usable in identifying another MME (MME-RD), such as a GUTI in 3GPP LTE compliant communications systems, the MME-UE may be able to obtain the security context from the MME-RD. If the MME-UE obtains the security context during the relay service request forwarding, a tracking area update (TAU) may be used since general packet radio service (GPRS) tunneling protocol (GTP) signaling for retrieving a UE context exists in the interface between two MMEs with the requirement to include information from a TAU message. However, current technical standards do not allow for the UE context exchange without the TAU message.

According to an example embodiment, a TAU message, including the necessary parameters for the UE context exchange, is included in the relay service request. Furthermore, the TAU message is sent as an INITIAL UE MESSAGE from an eNB to MME-UE during the setup of resources for the RD.

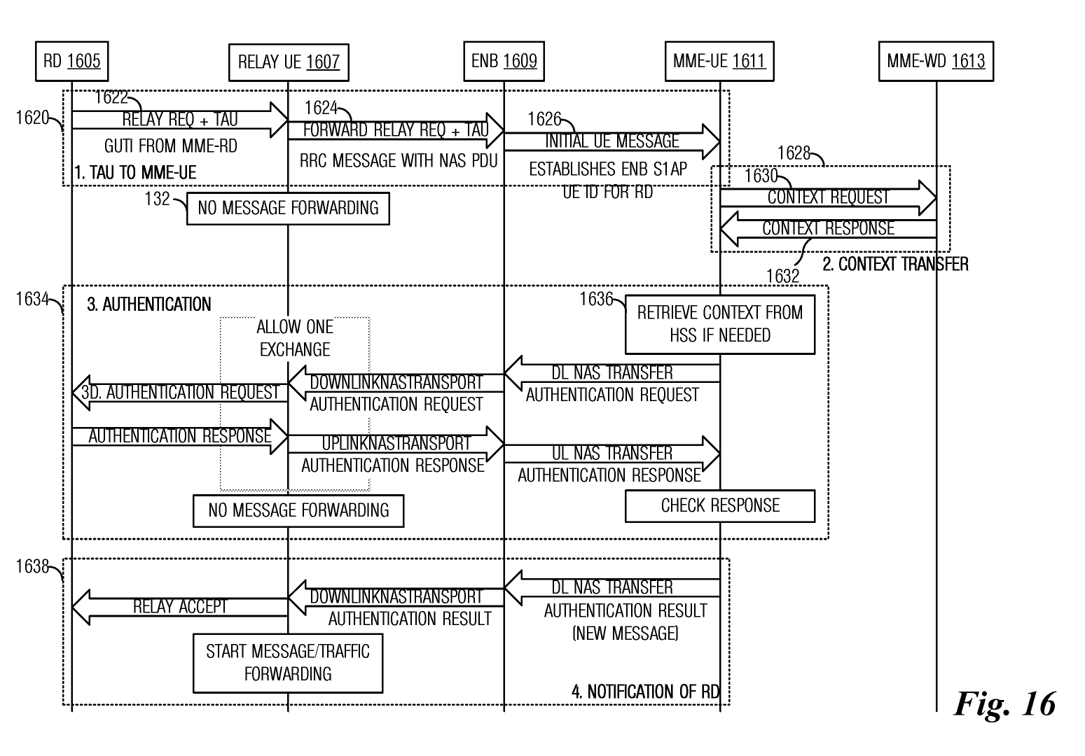

FIG. 16 illustrates a message exchange diagram 1600 of messages exchanged and processing occurring in a communications system highlighting a UE context exchange included in a TAU message in a relay service request. Message exchange diagram 1600 displays messages exchanged and processing occurring at a RD 1605, a relay UE 1607, an eNB 1609, a MME-UE 1611, and a MME-RD 1613.

Block 1620 of message exchange diagram 1600 displays messages exchanged in processing a relay service request. The relay service request may be a way to get the TAU message to MME-UE 1611. The relay service request includes RD 1605 sending a relay service request with a TAU message to relay UE 1607 (event 1622). The TAU message may include a GUTI of RD 1605 that covers MME-RD 1613. Relay UE 1607 forwards the relay service request with the TAU message to eNB 1609 (event 1624). A radio resource control (RRC) message with a NAS protocol data unit (PDU) may be used to forward the relay service request with the TAU message. eNB 1609 sends the TAU message as an INITIAL UE MESSAGE to MME-UE 1611 (event 1626). The INITIAL UE MESSAGE establishes the eNB S1AP UE ID for RD 1605. As a result of the TAU message and the GUTI included therein, MME-UE 1611 is able to identify MME-RD 1613 and perform a UE context transfer 1628, which includes a UE context request 1630 and a UE context response 1632.

Block 1634 of message exchange diagram 1600 displays messages exchanged and processing performed during authentication. Authentication proceeds in a manner as described previously, and in block 1636, MME-UE 1611 may be able to retrieve the UE context if MME-UE 1611 was unable to retrieve the UE context in UE context transfer 1628. In other words, if MME-UE 1611 was unable to contact MME-RD 1613, MME-UE 1611 may be able to retrieve the UE context from a HSS during the authentication of RD 1605. Message exchange diagram 1600 also includes block 1638, notification of RD 1605.

According to another example embodiment, a MME-UE triggers the UE context exchange during RD authentication as if the UE context request had failed during a TAU message exchange. If the security context request fails during an actual TAU message exchange, the MME-UE may directly trigger the UE context exchange with a HSS of the RD during the authentication of the RD. In this example embodiment, the same direct triggering of the UE context exchange with the HSS is used, even though no TAU procedure is in progress.

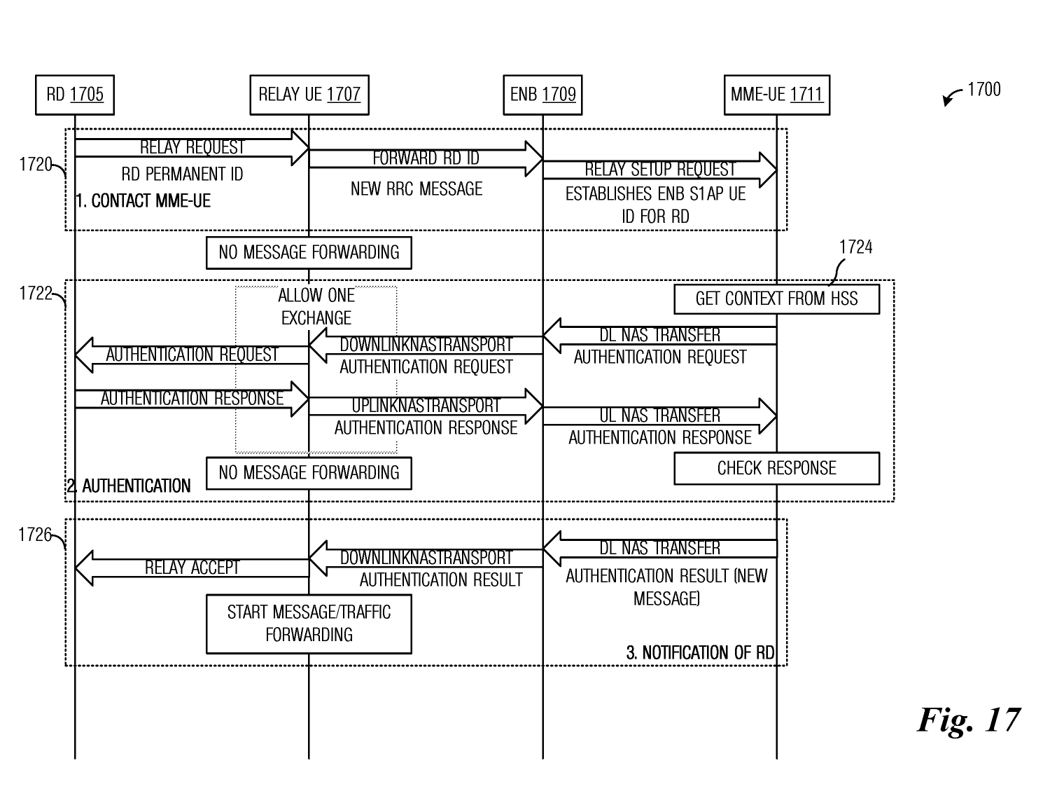

FIG. 17 illustrates a message exchange diagram 1700 of messages exchanged and processing occurring in a communications system highlighting a UE context exchange triggered during RD authentication. Message exchange diagram 1700 displays messages exchanged and processing occurring at a RD 1705, a relay UE 1707, an eNB 1709, and a MME-UE 1711.

Block 1720 of message exchange diagram 1700 displays messages exchanged in a relay service request. Block 1722 of message exchange diagram 1700 displays messages exchanged and processing performed during RD authentication. During RD authentication, MME-UE 1711 obtains the UE context of RD 1705 from a HSS of RD 1705 (block 1724) without first attempting to retrieve the UE context from a possibly existing MME-RD. The operation of MME-UE 1711 is as if a UE context exchange performed after the relay service request has failed or did not occur. It is noted that since the UE context exchanges without a MME-RD, the technique presented in message exchange diagram 1700 is operable in situations when a direct connection between RD 1705 and the core network does not exist. In other words, message exchange diagram 1700 is operable during an initial attachment of RD 1705 to the core network. Message exchange diagram 1700 also includes block 1726, notification of RD 1705.

According to yet another example embodiment, the UE context request and response interaction is permitted without the TAU message exchange. The relay service request includes a GUTI or permanent RD ID that may be used by the MME-UE to request the UE context of the RD from the MME-RD. If the UE context transfer fails or does not occur, the UE context may be retrieved during RD authentication.

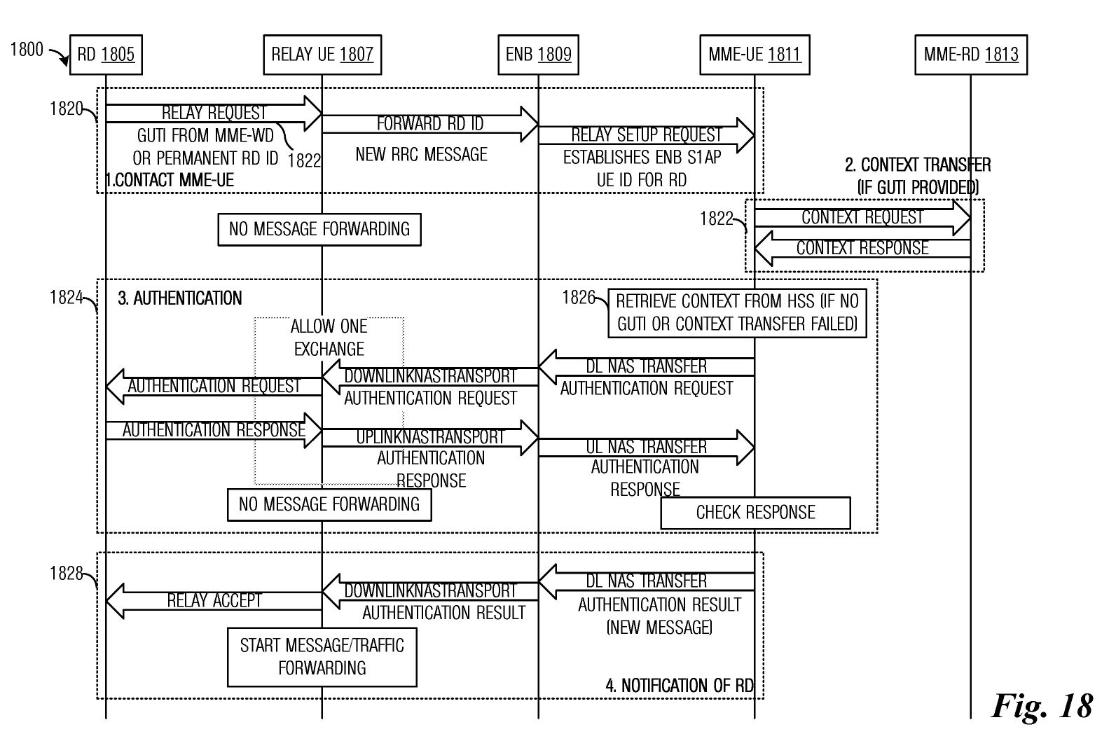

FIG. 18 illustrates a message exchange diagram 1800 of messages exchanged and processing occurring in a communications system highlighting a relay service request including an identifier covering a RD. Message exchange diagram 1800 displays messages exchanged and processing occurring at a RD 1805, a relay UE 1807, an eNB 1809, a MME-UE 1811, and a MME-RD 1813.

Block 1820 of message exchange diagram 1800 displays messages exchanged in relay service request. The relay service request includes an identifier that covers MME-RD 1813, such as a GUTI or a permanent identifier. The relay service request is a way to get the identifier to MME-UE 1811. The relay service request includes RD 1805 sending a relay service request with the identifier to relay UE 1807 (event 1822). The identifier is forwarded, in a RRC message, for example, to eNB 1809, which sends the identifier in an INITIAL UE MESSAGE to MME-UE 1811. As a result of the INITIAL UE MESSAGE and the identifier included therein, MME-UE 1811 is able to identify MME-RD 1813 and perform a UE context transfer 1822, without an accompanying TAU procedure, and specifically without including valid information related to a TAU message in the context request message of UE context transfer 1822.

If UE context transfer 1822 fails or does not occur, the UE context may be obtained by MME-UE 1811 during RD authentication 1824 from a HSS (block 1826). Message exchange diagram 1800 also includes block 1826, notification of RD 1805.

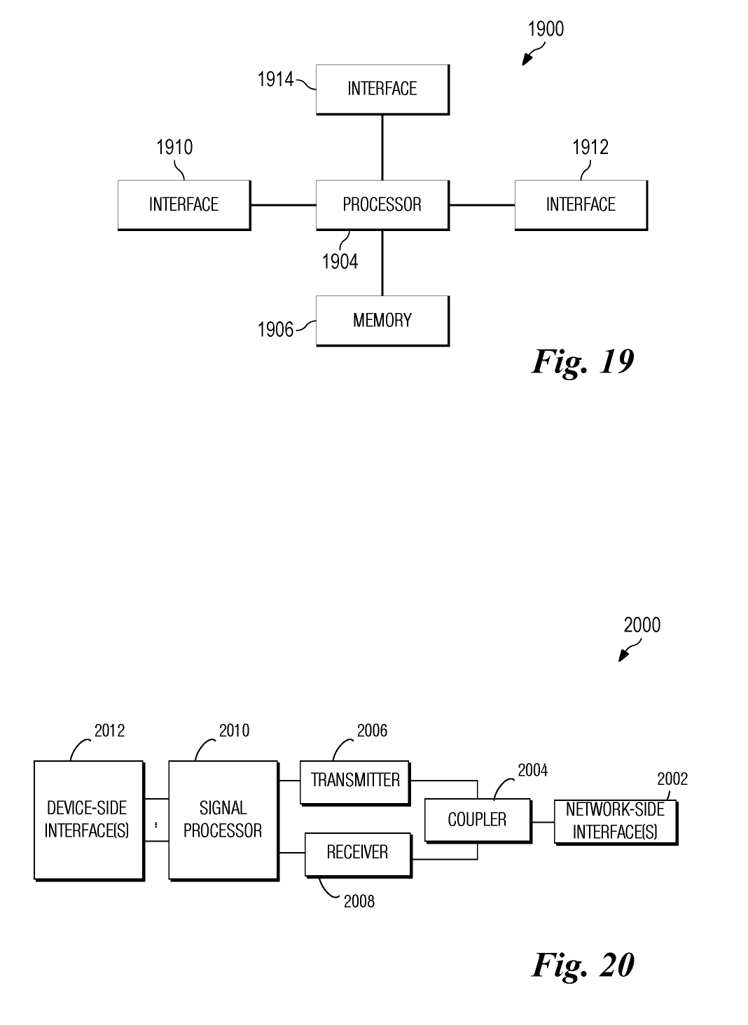

FIG. 19 illustrates a block diagram of an embodiment processing system 1900 for performing methods described herein, which may be installed in a host device. As shown, the processing system 1900 includes a processor 1904, a memory 1906, and interfaces 1910-1914, which may (or may not) be arranged as shown in FIG. 19. The processor 1904 may be any component or collection of components adapted to perform computations and/or other processing related tasks, and the memory 1906 may be any component or collection of components adapted to store programming and/or instructions for execution by the processor 1904. In an embodiment, the memory 1906 includes a non-transitory computer readable medium. The interfaces 1910, 1912, 1914 may be any component or collection of components that allow the processing system 1900 to communicate with other devices/components and/or a user. For example, one or more of the interfaces 1910, 1912, 1914 may be adapted to communicate data, control, or management messages from the processor 1904 to applications installed on the host device and/or a remote device. As another example, one or more of the interfaces 1910, 1912, 1914 may be adapted to allow a user or user device (e.g., personal computer (PC), etc.) to interact/communicate with the processing system 1900. The processing system 1900 may include additional components not depicted in FIG. 19, such as long term storage (e.g., non-volatile memory, etc.).

In some embodiments, the processing system 1900 is included in a network device that is accessing, or part otherwise of, a telecommunications network. In one example, the processing system 1900 is in a network-side device in a wireless or wireline telecommunications network, such as a base station, a relay station, a scheduler, a controller, a gateway, a router, an applications server, or any other device in the telecommunications network. In other embodiments, the processing system 1900 is in a user-side device accessing a wireless or wireline telecommunications network, such as a mobile station, a user equipment (UE), a personal computer (PC), a tablet, a wearable communications device (e.g., a smartwatch, etc.), or any other device adapted to access a telecommunications network.

In some embodiments, one or more of the interfaces 1910, 1912, 1914 connects the processing system 1900 to a transceiver adapted to transmit and receive signaling over the telecommunications network. FIG. 20 illustrates a block diagram of a transceiver 2000 adapted to transmit and receive signaling over a telecommunications network. The transceiver 2000 may be installed in a host device. As shown, the transceiver 2000 comprises a network-side interface 2002, a coupler 2004, a transmitter 2006, a receiver 2008, a signal processor 2010, and a device-side interface 2012. The network-side interface 2002 may include any component or collection of components adapted to transmit or receive signaling over a wireless or wireline telecommunications network. The coupler 2004 may include any component or collection of components adapted to facilitate bi-directional communication over the network-side interface 2002. The transmitter 2006 may include any component or collection of components (e.g., up-converter, power amplifier, etc.) adapted to convert a baseband signal into a modulated carrier signal suitable for transmission over the network-side interface 2002. The receiver 2008 may include any component or collection of components (e.g., down-converter, low noise amplifier, etc.) adapted to convert a carrier signal received over the network-side interface 702 into a baseband signal. The signal processor 2010 may include any component or collection of components adapted to convert a baseband signal into a data signal suitable for communication over the device-side interface(s) 2012, or vice-versa. The device-side interface(s) 2012 may include any component or collection of components adapted to communicate data-signals between the signal processor 2010 and components within the host device (e.g., the processing system 1900, local area network (LAN) ports, etc.).

The transceiver 2000 may transmit and receive signaling over any type of communications medium. In some embodiments, the transceiver 2000 transmits and receives signaling over a wireless medium. For example, the transceiver 2000 may be a wireless transceiver adapted to communicate in accordance with a wireless telecommunications protocol, such as a cellular protocol (e.g., long-term evolution (LTE), etc.), a wireless local area network (WLAN) protocol (e.g., Wi-Fi, etc.), or any other type of wireless protocol (e.g., Bluetooth, near field communication (NFC), etc.). In such embodiments, the network-side interface 2002 comprises one or more antenna/radiating elements. For example, the network-side interface 2002 may include a single antenna, multiple separate antennas, or a multi-antenna array configured for multi-layer communication, e.g., single input multiple output (SIMO), multiple input single output (MISO), multiple input multiple output (MIMO), etc. In other embodiments, the transceiver 2000 transmits and receives signaling over a wireline medium, e.g., twisted-pair cable, coaxial cable, optical fiber, etc. Specific processing systems and/or transceivers may utilize all of the components shown, or only a subset of the components, and levels of integration may vary from device to device.

It should be appreciated that one or more steps of the embodiment methods provided herein may be performed by corresponding units or modules. For example, a signal may be transmitted by a transmitting unit or a transmitting module. A signal may be received by a receiving unit or a receiving module. A signal may be processed by a processing unit or a processing module. Other steps may be performed by a restricting unit/module, an unrestricting unit/module, and an applying unit/module. The respective units/modules may be hardware, software, or a combination thereof. For instance, one or more of the units/modules may be an integrated circuit, such as field programmable gate arrays (FPGAs) or application-specific integrated circuits (ASICs).

Although the present disclosure and its advantages have been described in detail, it should be understood that various changes, substitutions and alterations can be made herein without departing from the spirit and scope of the disclosure as defined by the appended claims.

What is claimed is:

1. A method for providing relay services to a remote device (RD) of a communications system, the method comprising:
receiving, by a relay device, a relay service request from the RD, the relay service request including at least an identifier of the RD, and the RD is not in active radio communications with an entity of the communications system;
restricting, by the relay device, relay services on communications from the RD;
sending, by the relay device, a first authentication request including at least a portion of the relay service request to a network node;
receiving, by the relay device, a second authentication response confirming the identity of the RD; and
unrestricting, by the relay device, the relay services on communications from the RD.

2. The method of claim 1, wherein the RD is attached to the communications system through a previously established radio connection.

3. The method of claim 1, wherein restricting the relay services comprises blocking all communications from the RD, and wherein the relay service request further includes a cryptographic signature covering at least the identity of the RD.

4. The method of claim 3, wherein the relay service request further comprises a freshness parameter.

5. The method of claim 3, wherein the first authentication request requests authentication of the cryptographic signature.

6. The method of claim 3, wherein the first authentication request includes the identifier of the RD and the cryptographic signature.

7. The method of claim 1, wherein restricting the relay services comprises blocking all communications from the RD other than messages associated with an authentication procedure.

8. The method of claim 7, further comprising:
sending, by the relay device, a second authentication request to the RD;
receiving, by the relay device, a second authentication response from the RD; and
sending, by the relay device, the second authentication response.

9. The method of claim 1, further comprising:
applying, by the relay device, admission controls on the RD in accordance with the identifier of the RD.

10. The method of claim 9, wherein applying admission controls comprises at least one of applying a whitelist, applying a blacklist, prompting an owner of the relay device, and examining a subscription of the relay device.

11. A relay device adapted to provide relay services to a remote device (RD) of a communications system, the relay device comprising:
a processor; and
a computer readable storage medium storing programming for execution by the processor, the programming including instructions to configure the relay device to:
receive a relay service request from the RD, the relay service request including at least an identifier of the RD, and the RD is not in active radio communications with an entity of the communications system,
restrict relay services on communications from the RD,
send a first authentication request including at least a portion of the relay service request to a network node,
receive a second authentication response confirming the identity of the RD, and
unrestrict the relay services on communications from the RD.

12. The relay device of claim 11, wherein the programming includes instructions to block all communications from the RD, and wherein the relay service request further includes a cryptographic signature covering at least the identity of the RD.

13. The relay device of claim 12, wherein the relay service request further comprises a nonce.

14. The relay device of claim 11, wherein the programming includes instructions to block all communications from the RD other than messages associated with an authentication procedure.

15. The relay device of claim 11, wherein the programming includes instructions to send a second authentication request to the RD, receive a second authentication response from the RD, and send the second authentication response.

16. The relay device of claim 11, wherein the programming includes instructions to apply admission controls on the RD in accordance with the identifier of the RD.

17. The relay device of claim 16, wherein the programming includes instructions to at least one of apply a whitelist, apply a blacklist, prompt an owner of the relay device, and examine a subscription of the relay device.

18. The relay device of claim 11, wherein the relay device and the RD are connect by a short-range wireless connection that is different from a wireless connection connecting the relay device to the communications system.

19. A non-transitory computer-readable medium storing programming for execution by a processor, the programming including instructions to:
receive a relay service request from a remote device (RD), the relay service request including at least an identifier of the RD, and the RD is not in active radio communications with an entity of a communications system including the RD;
restrict relay services on communications from the RD;
send a first authentication request including at least a portion of the relay service request to a network node;
receive a second authentication response confirming the identity of the RD; and
unrestrict the relay services on communications from the RD.

20. The non-transitory computer-readable medium of claim 19, wherein the programming includes instructions to block all communications from the RD, and wherein the relay service request further includes a cryptographic signature covering at least the identity of the RD.

21. The non-transitory computer-readable medium of claim 19, wherein the programming includes instructions to block all communications from the RD other than messages associated with an authentication procedure.

22. The non-transitory computer-readable medium of claim 19, wherein the programming includes instructions to send a second authentication request to the RD, receive a second authentication response from the RD, and send the second authentication response.

23. The non-transitory computer-readable medium of claim 19, wherein the programming includes instructions to apply admission controls on the RD in accordance with the identifier of the RD.
